(19) United States
(12) Patent Application Publication
(10) Pub. No.: US 2025/0190594 A1
(43) Pub. Date: Jun. 12, 2025

(54) System and Method for Light Data File Upload Prevention

(71) Applicant: Proofpoint, Inc., Sunnyvale, CA (US)

(72) Inventors: Nir Barak, Karmei Yosef (IL); Boris Traktirnik, Ashdod (IL); Ilia Shterenberg, Netanya (IL)

(21) Appl. No.: 18/842,501

(22) PCT Filed: Mar. 2, 2023
(86) PCT No.: PCT/US2023/063551

§ 371 Date: Aug. 29, 2024

Related U.S. Application Data
(60) Provisional application No. 63/316,493, filed on Mar. 4, 2022.

(51) Int. Cl. G06F 21/60; G06F 21/55

(52) U.S. Cl. CPC G06F 21/606; G06F 21/554

(57) ABSTRACT

A system preventing upload of a source file to an upload destination includes a computer, a user application, and an agent application. The agent registers for a notification of a user interface action with the computer operating system (OS), and receives notice from the OS of the user interface action associated with the registering. The agent determines the user interface action is indicative of a data file upload operation of a source file to an upload destination. The agent compares a property of the source file and a property of the upload destination to a blocking criteria and prevents the user application from receiving the user interface action. The user interface action includes detection by the OS of a user interaction with a controller of a graphical user interface pointer and/or a pressing of one or more keys on a keyboard user interface.

### CROSS-REFERENCE TO RELATED APPLICATIONS

This application claims the benefit of U.S. Provisional Patent Application Ser. No. 63/316,493, filed Mar. 4, 2022, entitled “System and Method for Light Data File Upload Prevention,” which is incorporated by reference herein in its entirety.

### FIELD OF THE INVENTION

The present invention relates to data security, and more particularly, is related to preventing unauthorized file upload operations.

### BACKGROUND OF THE INVENTION

Many organizations wish to protect sensitive computer data files. However, it can be difficult to prevent unauthorized data file uploads from company computing devices, for example, uploading data files from a memory location managed by the organization onto an external destination not controlled by the organization, such as a network/cloud destination.

Previous methods of preventing a file upload action have been based on file properties and content upload location and user info, sometimes using code injection inside the browser, a browser plugin, or a network proxy. Such methods may be intrusive to processes running in context, potentially leading to a crash of the application or compatibility issues. Similarly, such methods may involve whitelisting to other techniques while working in a protected environment including Antivirus and Antimalware solutions. While browser based file upload prevention may be less intrusive, it must be implemented browser by browser, and a common update to any particular browser may break the implementation. While a proxy solution can be effective in blocking uploads, such a solution needs to change routing and setup on the machine, and since it is on the network, this method is primarily mainly based on the identity of the source machine and target but does not cover the aspects such as the original user context, which user is performing the action resulting in the upload, what other actions the user may be performing.

Therefore, there is a need in the industry to address one or more of the abovementioned shortcomings.

### SUMMARY OF TUE INVENTION

Embodiments of the present invention provide a system and method for light data file upload prevention. Briefly described, the present invention is directed to a system and method preventing upload of a source file to an upload destination. The system includes a computer, a user application, and an agent application. The agent registers for a notification of a user interface action with the computer operating system (OS), and receives notice from the OS of the user interface action associated with the registering. The agent determines the user interface action is indicative of a data file upload operation of a source file to an upload destination. The agent compares a property of the source file and a property of the upload destination to a blocking criteria and prevents the user application from receiving the user interface action. The user interface action includes detection by the OS of a user interaction with a controller of a graphical user interface pointer and/or a pressing of one or more keys on a keyboard user interface.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a schematic block diagram of a computer accessed by a user under a first embodiment of the present invention.

FIG. 2 is a flowchart of an exemplary first embodiment of a method for blocking a file upload.

FIG. 3 shows a schematic block diagram 300 providing additional details of the process of FIG. 2.

FIG. 4A is a schematic block diagram showing a path of an unblocked user upload action in the computer of FIG. 1.

FIG. 4B is a schematic block diagram showing a path of a blocked user upload action in the computer of FIG. 1.

FIG. 5 is a schematic diagram illustrating an example of a system for executing functionality of the present invention.

FIG. 6 is a block diagram of an embodiment of a system implementing the embodiments.

FIG. 7 is a screenshot of an exemplary notification of a blocked file upload.

### DETAILED DESCRIPTION

The following definitions are useful for interpreting terms applied to features of the embodiments disclosed herein, and are meant only to define elements within the disclosure.

As used within this disclosure, a “data file upload” operation generally refers to the overall process of transferring a selected source file located on a first (“host” or “local”) device over a communication network to a remote device, for example, a server. The data file upload may be broken down into two mid-level operations: a source file selection operation and an uploading operation. The source file selection operation includes receiving a user selection of a source file stored at a first location (“source file location”). The upload operation includes indication of a target destination, for example, a target server. In some cases, the file upload operation also involves copying a reference to the source file to an intermediate storage location, such as a buffer or cache (for example, a “clipboard” of the operating system), before the source file data is uploaded.

As used within this disclosure, a “file upload block,” a “blocking action,” “blocking,” and “block” refers to the prevention of a file upload operation before any data from the source file is uploaded to the destination location. In the embodiments described below, the block may implemented by preventing an application from receiving a user interface action indicative of a file upload.

As used within this disclosure, a “controller of a graphical user interface pointer” refers to any physical wired or wireless user interface device or user sensor configured to control a graphical pointer object for a two dimensional (2D) or three dimensional (3D) graphical user interface, for example but not limited to a mouse, trackpad, track point, track button, track knob, trackball, and a gesture and/or motion sensor of, for example, a virtual reality (VR) headset. Such devices may be wired or wireless.

As used within this disclosure, a “user interaction with the controller of the graphical user interface pointer” includes one or more of a click, a click-and-release, a click-and-hold, a click-and-drag, and a click-and-drag-and-release (“drag-and-drop”).

As used within this disclosure, a “user keyboard action” refers to the detected pressing of one or more keys on a keyboard computer interface, whether wired or wireless. A keyboard action may involve a combination of a character key and a control key, such as control/command, option, alt, meta, or shift, among others. Likewise, a user keyboard action may refer to a sequence of key presses, for example, the entering of a text string into a command line.

As used within this disclosure, a “user interface action” may refer to a detected user interaction with a UI device such as a character input device (keyboard) and/or the controller of the graphical user interface pointer, either alone or in combination, for example pressing and holding of a command key or other keyboard key combination while clicking with a mouse or trackpad. Other types of user interaction are also possible, for example facial and/or body gesture recognition. Analyzing a user interface action may involve determining a selected menu item during the user interface action, for example, an entry in a pop-up menu or drop-down menu in proximity of a pointer object during the user interface action, as described in the patent application PCT/US2020/012133, published as WO 2020/142654 A1, entitled “Detecting Paste and Other Types of User Activities in Computer Environment,” which is incorporated by reference herein in its entirety.

As used within this disclosure, a “blocking criteria” refers to a set of rules and/or conditions used to determine whether a data file upload operation is to be allowed or blocked, for example, blocked at the application level. The blocking criteria may be based on one or more properties of the source file, and/or the upload location. Properties of the source file may include the source file location, a title of the source file, content of the source file data (for example, a listed text string), information regarding a file classification indicating whether the source file includes sensitive information, information regarding permissions needed to access the source file, and/or metadata associated with the source data file, among other properties. Properties of the upload location may include, for example, whether the destination file location is included in an approved list (“whitelist”). For example, the approved whitelist may include full URLs, partial URLs (such as the top level site), and/or a category of the URL (such as news, among others).

As used within this disclosure, “code injection” refers to the practice of instrumenting and/or extending OS level functions by injecting of computer code into function binaries. For example, code injection may be implemented by re-writing the in-memory code for target functions. As used within this disclosure, a “file path” or “path” refers to the general form of the name of a file or directory that specifies a unique location in a file system on a computer or computer network. The OS uses the path to locate files in the file system.

As used within this disclosure, a “file picker” refers to a software utility accessible by a computer application used to selectively access, browse, and save files and folders on the computer system. The file picker is typically provided via a call to the computer operating system. The operating system of the host computer may provide a registration/notification for file picker actions.

As used within this disclosure, a “pick operation” refers to functionality performed by a file picker.

As used within this disclosure, a “target window” refers to a viewing area in the UI, for example a window, controlled by the application that is the intended recipient of the user interface action.

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention provide a system and method for a light and non-intrusive preventing of a file upload action initiated via a user application. The file upload action may be triggered by either a mouse action or a keyboard action within a user application according to a source file targeted for upload. The embodiments may listen for mouse and keyboard events (on the UI level) to detect the upload event, and then performs a fast scan into the clipboard/pasteboard and or drag information. Alternatively, the embodiments may detect file picker objects to identify the source file and inspect a target window to identify the upload location. The embodiments may inspect the target window to determine the target URL for the upload operation to decide whether or not to block the upload operation. If the embodiments determines the upload operation should be blocked, the mouse or keyboard event is dropped, so the intended upload operation does not result in forwarding of the source file information to the target application performing the file upload. Here, the OS 815 UI infrastructure captures the keyboard and mouse events before they reach the target application, so the target application never learns of the user interface action (for example, keyboard and/or mouse events) that would have otherwise effectuated a file upload operation. The embodiments may block the events by simulating a user press of the escape key (by canceling the operation and freeing the mouse pointer), so besides dropping the event, the user interface activity is also released.

In some instances, the embodiments may temporarily block an upload while a background process verifies the source file or upload destination. For example, if an upload blocking rule/criteria includes scanning the source file for content and the content scanning results for the file are unknown or incomplete, and/or the target URL is protected, the upload action may be initially blocked while background scanning is performed. Here, the embodiments may alert the user, for example, by presenting a message box, to try the upload again after the content scan is complete. Likewise, the embodiments may alert the user if the rules/criteria do not permit the upload.

In general, under the embodiments the data file upload operation is attempted in the context of an application in communication with the OS 815, where the application relies on the OS 815 to convey the UI actions initiating the data file upload operation.

In general, the file upload blocking may occur after the source file targeted for uploading has been selected in one of three ways: (1) the source file is copied into a clipboard/pasteboard of the host computer, (2) the file to be uploaded is selected via a drag-and-drop operation, or (3) the file to be uploaded is selected via use of a file picker.

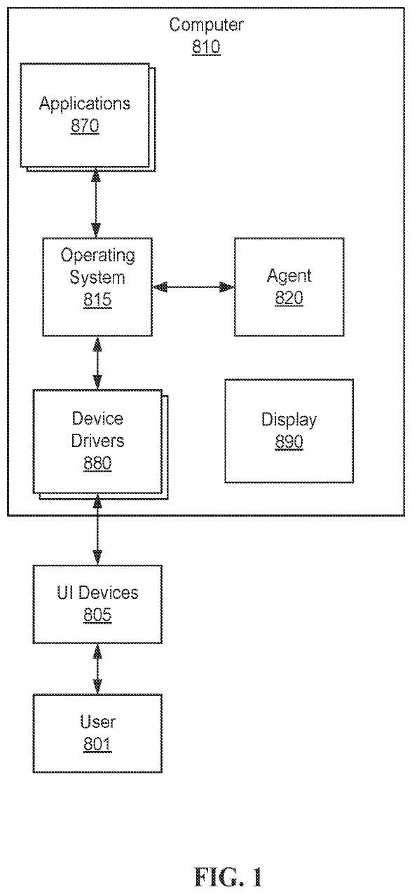

FIG. 1 is a simplified schematic block diagram of a computer 810 accessed by a user 801 under a first embodiment of the present invention. The user generally runs one or more applications 840 hosted on or presented via the computer 810. The user 801 interacts with the computer 810 via one or more user interface (UI) devices 805, for example a keyboard, a mouse, a trackpad, a microphone, among others, and the computer 810 presents information to the user 801 via a display 890 and/or an audio transducer (not shown). User input via the UI devices 805 is received by respective device drivers 880 for the UT devices 805, and the device drivers 880 convey the input of the user 801 to the operating system 815. The operating system 815 in turn interacts with the applications 870, for example, conveying the user actions to the applications 870. As described in further detail below, an agent 820 installed in the computer 810 is privy to the user interface actions of the user 801 via the operating system 815, and may intercede to prevent the user interface actions from reaching the applications 870.

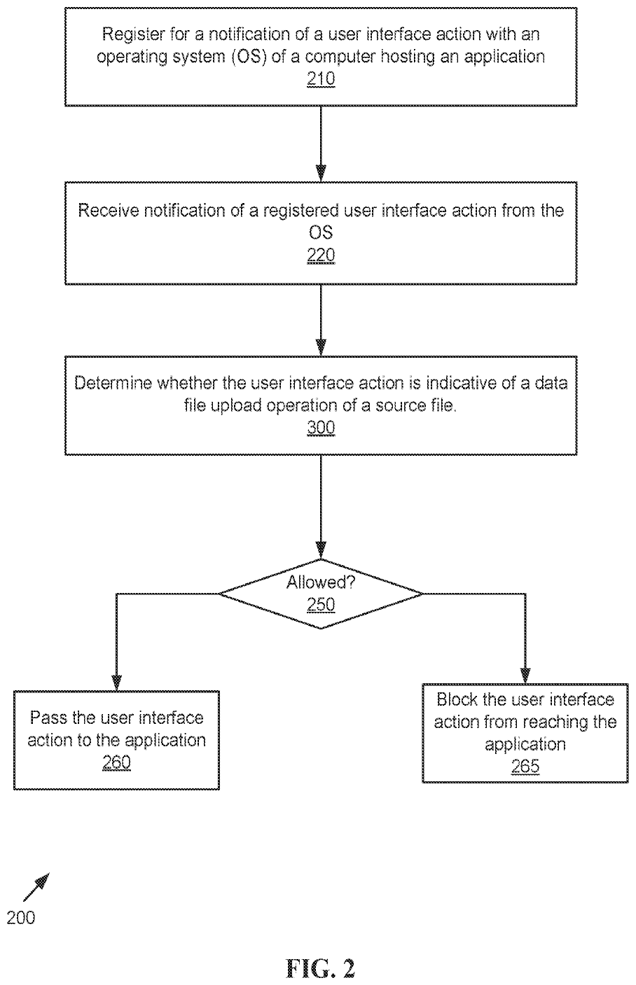

FIG. 2 is a flowchart 200 of a first exemplary embodiment of a method to block a data file upload. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

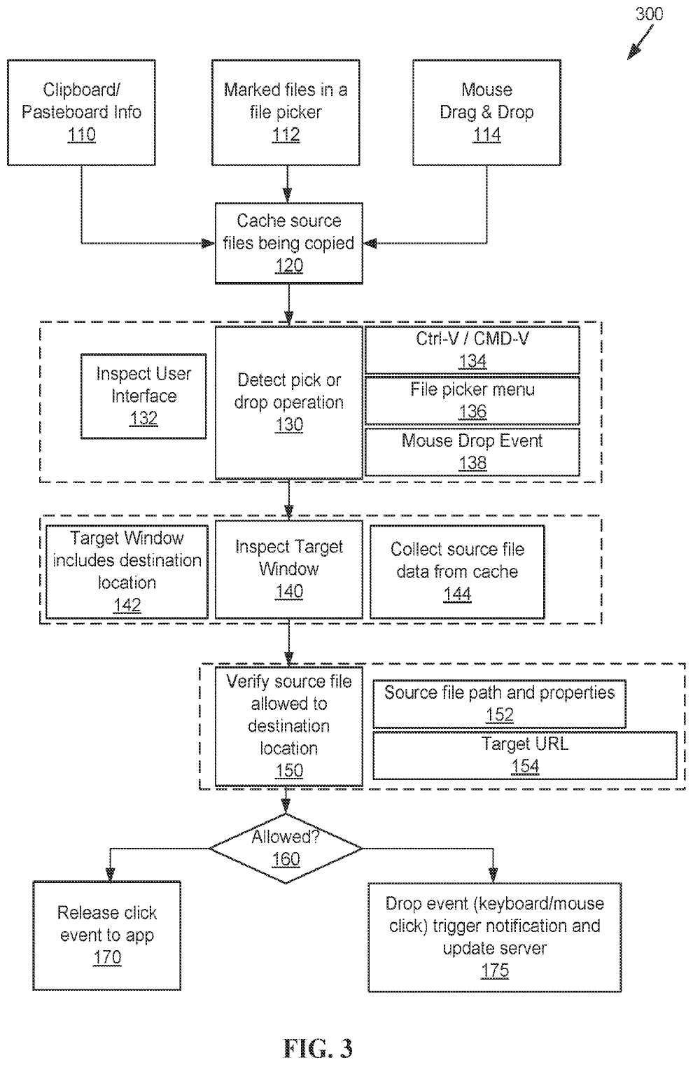

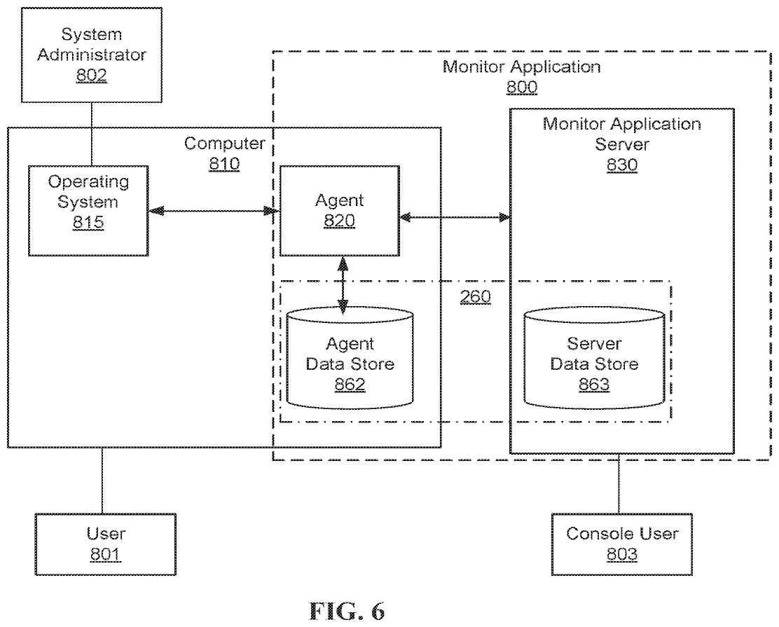

An agent 820 (FIG. 1) registers for notification of user interface actions with an operating system (OS) 815 (FIG. 1) of a computer 810 (FIG. 1) running an application 870 (FIG. 1) for a user (801), as shown by block 210. The agent 820 (FIG. 1) receives notice from the OS 815 (FIG. 1) of a user interface action associated with the registering, as shown by block 220. The agent 820 (FIG. 1), for example, on its own or in collaboration with a monitor application 800 (FIG. 6) determines whether the user interface action is indicative of a data file upload operation of a source file, as shown by block 300. The details of block 300 are described below with regard to FIG. 3. If the data file upload operation is allowed, as per the blocking criteria (see block 250), the agent 820 (FIG. 1) passes the user interface action to the application 870 (FIG. 1), as shown by block 260. If the data file upload operation is not allowed, the agent 820 (FIG. 1) blocks the user interface action from reaching the application 870 (FIG. 1), as shown by block 265. The structure and operation of the agent 820 is discussed in further detail below with reference to FIG. 6.

FIG. 3 shows a schematic block diagram 300 providing additional details of the process of FIG. 2. A source file selection portion of a data file upload may involve, for example, a user interface action for copying of information regarding the source file to a cache, as shown by block 120, where the clipboard/pasteboard information 110 to be cached may be determined by a file picker marking a file for upload 112, an operation that moves a file to the OS clipboard, or a mouse drag-and-drop operation 114. Note, that merely copying the source file information to the cache may be insufficient to initiate block of a data file upload operation. Determination of a block of a data file upload operation generally occurs after a file paste, pick, or drop operation is detected, as per block 130. A file paste or drop may be determined by inspecting the user interface, as shown by block 132, or detecting a user interface action of keyboard key sequence, such as Ctrl-V or Cmd-V, as shown by block 134. A file pick may be determined by detecting a user interface action involving a user selection of a file picker menu item as shown by block 136. For example, the agent 820 (FIG. 1) may receive notification of a mouse click and determine whether the mouse click coincides with the display of a pop-up menu or a drop-down menu, and if so, determining whether the mouse cursor has selected a menu item corresponding to a pick operation. A mouse drop event of a drag-and-drop may be determined by detecting a user release of a held/dragged mouse, as shown by block 138.

Once the agent 820 (FIG. 1) has determined the result of the of the user interface action(s) is to upload a data file based on the notification of user action from the OS 815 (FIG. 1), the agent 820 (FIG. 1) determines the target window including the destination location for the file upload, as shown by block 142. For example, the agent 820 (FIG. 1) may determine the upload destination by the mouse pointer position at the release of a drag-and-drop operation, by a file path in a command line text field, and/or from the context of a dialog box where the user initiated the file upload request, among other means. The agent 820 (FIG. 1) inspects the file target window, as shown by block 140. For example, the target window may be determined when pasting a file after detecting a file drop (in a drag-and-drop operation), a keyboard sequence (pressing Ctrl-V CMD-V), a menu interaction (picking upload in a menu), and/or determining a focus window or a window pointed at by the mouse pointer. A full path of the upload destination may retrieved in several ways, including (but not limited to) by using accessibility hooks provided by the operating system as an accessibility API. In some cases, the accessibility hooks may obtain the path information from an application being used by the user.

The agent 820 (FIG. 1) collects source file information from the cache, as shown by block 144. The cache includes the full path for the source file. The agent 820 (FIG. 1) verifies whether the source file is allowed to be uploaded to the upload destination, as shown by block 150. The agent 820 (FIG. 1) verifies this according to the source file data collected from the cache, and from the source file path and properties, as shown by block 152.

For example, the agent 820 may determine whether the source data file is located, for example, in a folder defined as sensitive or appears on a sensitive device. Likewise, the agent 820 determines whether properties of the source data file itself indicates the source data file is sensitive. For example, the origin of the source file may be considered, such as via mail, or an internet site. Similarly, labels that may have been applied to the source data file, for example, an MIP label, may indicate whether the source file may be uploaded. Further, the agent 820 may scan content of the source data file for sensitive information which may classify the source data file as sensitive.

The agent 820 (FIG. 1) also uses the destination file location, such as the target URL, as shown by block 154, for example, to determine if the upload file location target is permitted. The agent 820 (FIG. 1) may determine this based upon a whitelist (described above), compared with predefined rules the customer may have defined for restriction of file uploading.

If the upload is allowed, the agent 820 (FIG. 1) releases the user interface upload action (for example, a mouse click) to the application 870 (FIG. 1), as shown by block 170. For example, under the win32 operating system, the SetWindowsHokExA function may be used to control the keyboard and mouse. If the upload is not allowed, the agent 820 (FIG. 1) drops the user upload action (keyboard/mouse click), as shown by block 175. For example, upon the drop the agent 820 (FIG. 6) may trigger a notification via a user session pop-up, and/or a notification may also be provided to subscribers on the server side such as the monitor application 800 (FIG. 6), for example, a monitor application server 830 for incident exploration.

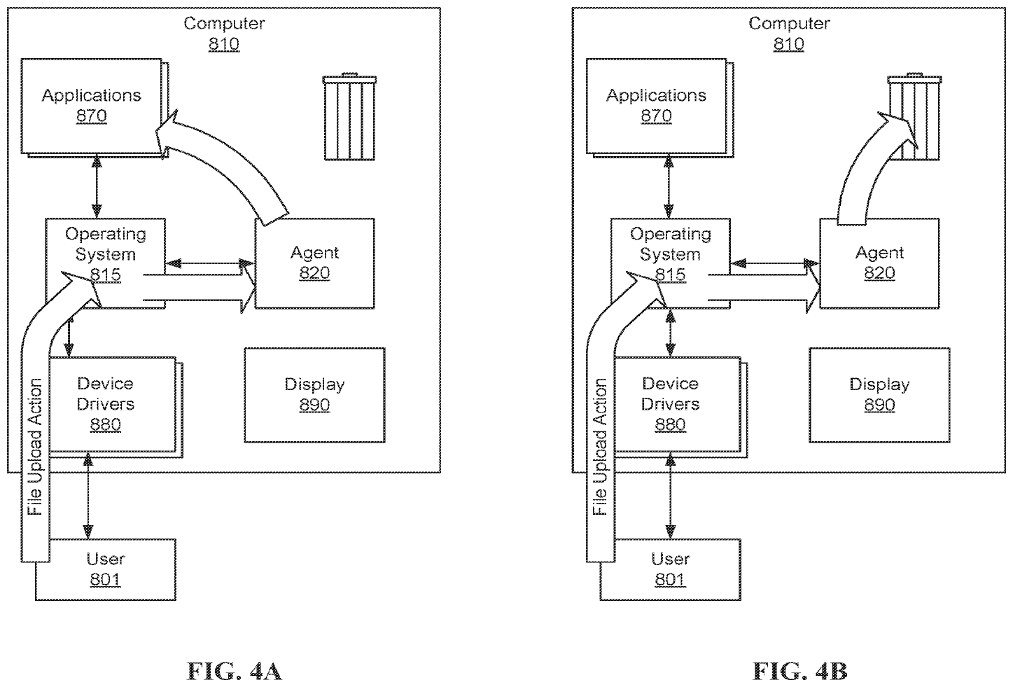

FIG. 4A shows white arrows indicating a flow of an unblocked user upload action in the computer 810 of FIG. 1. A file upload action by the user 801 is passed to the operating system 815 via the device driver 880, for example, a mouse device driver. The operating system 815 passes the notification of the user action indicative of a file upload to the agent 820, based on the agent 820 having previously registered with the OS 815 for such notifications. In FIG. 4A, the agent 820 determines that the file upload action is permissible, and passes the file upload action to the application 870.

FIG. 4B shows white arrows indicating a flow of a blocked user upload action in the computer 810. A file upload action by the user 801 is passed to the operating system 815 via the device driver 880, for example, a mouse device driver. The operating system 815 passes the notification of the user action indicative of a file upload to the agent 820 based on the agent 820 having previously registered with the OS 815 for such notifications. In FIG. 4B, the agent 820 determines that the file upload action is not permissible, and drops file upload action, depicted here by forwarding the file upload action to a trashcan icon.

As shown by FIGS. 4A-B, the application 870 is not privy to the decision whether to pass or block the file upload action. Likewise, the host computer OS 815 is not the arbiter of whether the upload is to be permitted, and no modification to the operating system is involved. This clearly illustrates the advantage of the first embodiment method over code injection at the OS 815 level or blocking actions at the application level.

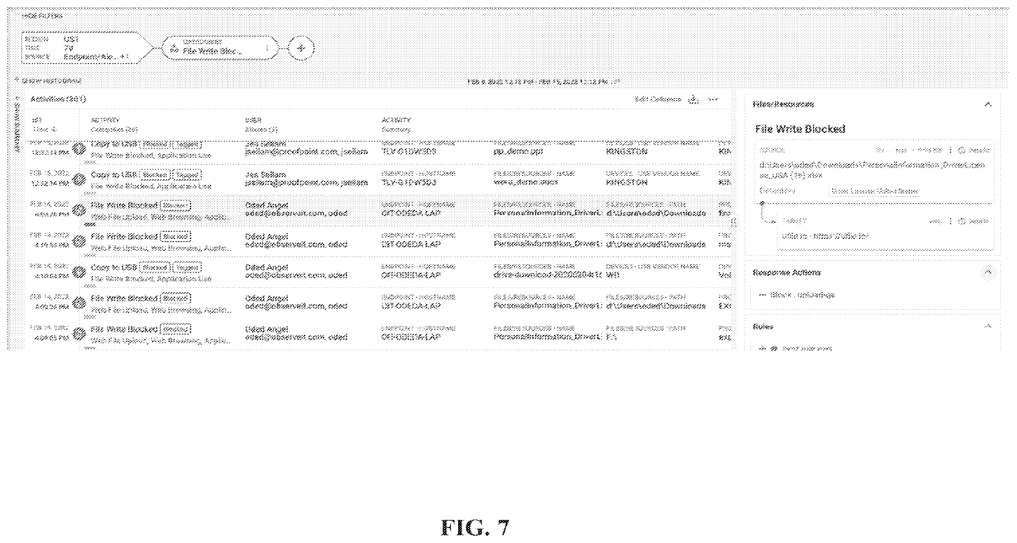

The exemplary embodiments may involve several steps, including one or more of:
(1) Detecting a copy into clipboard/pasteboard operation and identifying the files involved. Alternatively, in the case of a drag event, inspecting the dragged files from the pasteboard or inspecting user interface elements. The files involved are cached, or in the case of a file picker, the marked files are cached.
(2) Detecting a file upload event (or drop, in the case of drag-and-drop) and inspecting the target window to determine a target (destination) URL.
(3) Comparing the source file names and file properties to a list of allowed upload events into the target (based on the collected target as described above). Here, the embodiments also check if the file content sensitivity level is already known. If the file content sensitivity level is not known, the upload action may be dropped while the agent 820 performs a scan of the source file content. In this case, the user may be alerted (for example, via a pop up box) to attempt the upload action again after the scan has been completed.
(4) If the file upload operation is valid, for example, based on source file full path and properties, user/process information and the target URL, the agent 820 forwards the event data to the target application 870. If the file upload is not valid, the agent 820 drops the event, so the user interface action does not reach the target application 870.
(5) If the agent 820 blocks the upload event, the agent 820 triggers a user notification. FIG. 7 is a screenshot of an exemplary notification of a blocked file upload.
(6) The agent 820 may send the event information into a monitor application server 830 (FIG. 6) for incident exploration. For example, this may occur in a system having a software as a system (SAAS) agent, in which case, instead of an application server, a cloud service may perform a variety of actions, for example, consuming the data and allowing the user explorations, notifications, alerts, and tagging, among other services.

As described below in greater detail with reference to FIG. 6, the method embodiments described herein may be implemented in a system with a monitor application 800 having an agent 820 (FIG. 6) and a monitor application server. The agent 820 may be installed in a host device (for example, a computer 810 such as a desktop computer). The agent 820 is preferably implemented as an extension to the operating system (OS) 815 of the host device 810. An OS extension may leverage existing functionality of the OS 815 via one or more OS application programming interfaces (API), thereby operating in a manner consistent with the designers of the OS 815 that is unlikely to interfere with the normal operations of the host device 810.

For example, on an Apple Macintosh computer, the OS Accessibility API provides extensions so user interface devices (for example, keyboard, mouse, trackpad, among others.) may be customized to accommodate users with special needs. MacOS provisioning profiles, including Accessibility, allow remote setting of permissions for actions. This option can also be granted locally manually by the user in the security and privacy option. An Accessibility OS profile provides access to events such as keystrokes, mouse clicks, and other user activities that may be leveraged to monitor usage of the host device. This provides a global OS hook to intercept user mouse and keyboard activity. Similar OS hooks are available for other operating systems. The agent 820 may be implemented as a background process, such as a daemon, which may be installed in the computer 810 by a (human) system administrator 802 in a manner that is invisible and unobtrusive to a user 801 of the host device. Further, unlike a stand-alone application, a user 801 without system administrator privileges may not inadvertently (or intentionally) disable the background process.

The agent 820 may be configured to monitor for specific patterns of user activity, and to log and transmit log entries to the monitor application server 830. The monitor application server 830 may then catalog the user activity in a database stored within the server data store 863, and/or scan the log entries against a table of rules to determine if the host device 810 is being used in a manner of interest/concern. A console user (human) 803 may access the monitor application server 830, for example, using a web browser.

In general, it is desirable that the agent 820 operate in an unobtrusive manner, for example, without noticeably drawing on resources of the host device 810, such as processor power, storage capacity/throughput, and/or communication bandwidth. Similarly, it is desirable that the agent operate without introducing noticeable latency in response to actions of a user.

The agent 820 is notified by the OS 815 when the user 801 performs a mouse/keyboard action or enters a command indicative of uploading a file from the computer 810. The agent 820 uses the user action to access a collection, for example a database on the agent data store 862 containing rules for identifying sensitive files that the system administrator 802 does not want to have uploaded, as described in the embodiments. It should be noted that actions described herein taken by the agent 820 may in practice be undertaken by the agent 820 in conjunction with the monitor application 800 and/or other external processing resources. However, to avoid latency. the check to decide whether an action should be blocked or not may be based on rules downloaded to the agent 820 and cached locally.

FIG. 6 is a schematic diagram of an exemplary distributed implementation of the monitor application 800. The monitor application 800 includes an agent 820 that is resident in the computer 810, and a monitor application server 830, which as implemented here is remote from the computer 810, for example, in communication with the agent 820 via a wired or wireless communication network such as a local area network, a wide area network, or via the internet, for example, a cloud based server. The Agent 820 may be configured to communicate with the operating system 815 of the computer 810, for example, the agent 820 may register for notifications from the operating system 815 when a specified user related activity is detected by the operating system 815. Upon receipt of a notification from the operating system 815 by the agent 820, the agent 820 may communicate notification data received from the operating system 815 to the monitor application server 830. For example, the agent 820 may forward all received notification data to the monitor application server 830, or the agent may selectively forward selected notification data to the monitor application server 830. For example, the agent 820 may be configured by the monitor application server 830 with a blocking criteria to determine what notification data to forward to the monitor application server 830. The data store 860 may be distributed between an agent data store 862 resident on the computer 810 and a server data store 863 resident on the monitor application server 830. It should be noted the monitor application server 830 may be implemented as a cloud-based server.

The agent 820 may be tailored to communicate with a specific operating system 815 resident on the computer 810. For example, the agent 820 may be specific to Windows OS, MacOS, or Unix/Linux, among others. While FIG. 6 shows a single monitor application server 830, the monitor application server 830 may be distributed across two or more physical server devices. Likewise, the server data store 863 may be distributed across two or more physical server devices.

In general, the agent 820 may be configured to act as an intermediary between the operating system 815 and the monitor application server 830, in particular, the agent 820 generally conveys collected data to the monitor application server 830, and the monitor application server operates upon the collected data to determine if targeted activities have been performed by a user 801, here a human operating the computer 810. The system administrator 802 is a human who controls and configures the operating system 815 of the computer 810, and the console user 803 is a human who controls and interacts with the monitor application 800. Of course, there may be a plurality of users 801, system administrators 802, and/or console users 803, and in some circumstances a system administrator 802 and the console user 803 may be the same individual.

The flow of activity and communication between the components is as follows: The monitor application 800 includes an agent 820 which is installed locally on the computer 810. As noted above, for performance reasons the agent 820 generally performs the above embodiments based on rules stored in the agent data store 862. However, in some scenarios it may be desirable to apportion some of the workload to the monitor application. In such instances, the agent 820 captures user activity information, secures it, and sends the information to the monitor application server 830. In embodiments where there is more than one monitor application server 830, they may be load balanced with either a software or hardware-based device (not shown). In that case the agents 820 communicate with the load balancer's virtual internet protocol address(VIP).

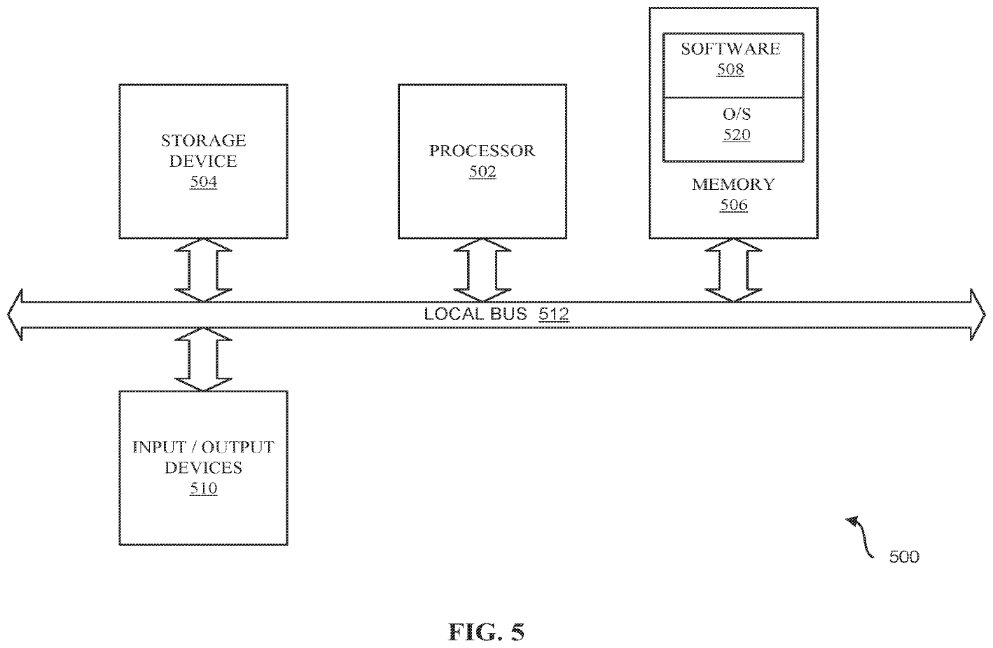

The present system for executing the functionality described in detail above may be a computer, an example of which is shown in the schematic diagram of FIG. 5. The system 500 contains a processor 502, a storage device 504, a memory 506 having software 508 stored therein that defines the abovementioned functionality, input, and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method.

Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As used within this disclosure, “file drag-and-drop” refers to a graphical user interface (GUI) initiation of a data file upload operation. For example, a file drag-and-drop operation may be implemented by a user selecting and dragging (for example, with a mouse or track pad) a first displayed graphical object representing a source file (“source file icon”) to a displayed second graphical object representing an upload destination (“destination icon”). Here, while the user mechanism for initiating the desired data file upload operation differs from the described embodiments, the underlying steps for the data file upload described above are unchanged at the OS level, so the file upload embodiments described herein are similarly applicable to a file drag-and-drop operation.

The embodiments described above are directed to a practical application for blocking uploading of sensitive computer files at the user interface level. Unlike upload blocking techniques at the application level, the embodiments described herein improve operation of the computer by using standard OS UI events to detect the data file upload attempt. Detection via OS UI events is not intrusive, has very low stability risk for the application, and does not introduce compatibility issues.

The embodiments provide for inspection of the source file path and properties of the file upload action as well as destination location, and are able to prevent the data file upload action before an upload action initiates.

The data file upload detection and prevention actions may be part of a user session and correlated with other user actions in the session monitored by and logged by the OS 815 and/or the agent 820. The user session data my include one or more screenshots optionally captured, for example, by the agent 820 to log the file upload activity. The user session data typically includes other actions with or without screenshots that occur during the user session before and/or after the upload event, as well as actions on the file prior to the event. The activity reported by the agent 820 may be used to generate alerts for later searches and/or to correlate actions later on the server side when the file upload detect or prevention event is available to the server 830.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for preventing upload of a computer source file to an upload destination, comprising:
a computer comprising a processor and a memory;
a user application accessed by a user via the computer;
an agent application hosted by the computer configured to perform the steps of:
registering for a notification of a user interface action with an operating system (OS) of the computer;
receiving notice from the OS of the user interface action associated with the registering;
determining the user interface action is indicative of a data file upload operation of a source file to an upload destination;
comparing a property of the source file and a property of the upload destination to a blocking criteria; and
preventing the user application from receiving the user interface action indicative of the data file upload operation of a source file to an upload destination,
wherein the user interface action comprises detection by the OS of a user interaction with a controller of a graphical user interface pointer and/or a pressing of one or more keys on a keyboard user interface.

2. The system of claim 1, wherein the step of the agent determining the user interface action is indicative of a data file upload operation of a source file to an upload destination further comprises detecting a data source file selection action.

3. The system of claim 1, wherein the agent is further configured to perform the steps of:
accessing source file properties of the source file; and
comparing the source file properties to the blocking criteria.

4. The system of claim 1, wherein the user interface action further comprises recognition by the OS facial and/or body gesture recognition.

5. The system of claim 1, further comprising a file picker configured to facilitate the user interface action.

6. A computer based method for preventing upload of a source file to an upload destination, comprising the steps of:
registering for a notification of a user interface action with an operating system (OS) of the computer;
receiving notice from the OS of the user interface action associated with the registering;
determining the user interface action is indicative of a data file upload operation of a source file to an upload destination;
comparing a property of the source file and a property of the upload destination to a blocking criteria; and
preventing the user application from receiving the user interface action indicative of the data file upload operation of a source file to an upload destination,
wherein the user interface action comprises detection by the OS of a user interaction with a controller of a graphical user interface pointer and/or a pressing of one or more keys on a keyboard user interface.

7. The method of claim 6, wherein the file upload operation comprises a data file selection.

8. The method of claim 7, wherein the file upload operation comprises a data file pick.

9. The method of claim 6, further comprising the steps of:
accessing source file properties of the source file; and
comparing the source file properties to the blocking criteria.

10. The method of claim 6, wherein the user interface action indicative of the file upload operation of the source file comprises a user interaction with a controller of a graphical user interface pointer.

11. The method of claim 6, wherein the user interface action indicative of the file upload operation of the source file comprises user interaction with a file picker configured to facilitate the user interface action.

12. The method of claim 10, wherein the user interaction with the controller of the graphical user interface pointer comprises at least one of the group of a click, a click-and-release, a click-and-hold, a click-and-drag, and a click-and-drag-and-release.

13. The method of claim 12, wherein the controller of the graphical user interface pointer comprises one of the group consisting of a mouse, a trackpad, a track point, a track button, a track knob, and a trackball.

14. The method of claim 6, wherein determining the user interface action is indicative of a data file upload operation of a source file to a destination file location further comprises detecting a data file pick action.

15. The method of claim 14, wherein blocking at least a portion of the user interface action indicative of the data file upload operation from reaching the application comprises dropping the data file pick action.

16. The method of claim 6, further comprising the step of informing the user of the preventing of the user application from receiving the user interface action.

17. The method of claim 6, wherein:
the user interface action comprises a sequence of key presses; and
determining the user interface action is indicative of a data file upload operation further comprises the step of parsing the sequence of key presses.

18. The method of claim 6, wherein the user interface action further comprises recognition by the OS facial and/or body gesture recognition.

19. The method of claim 6, further comprising the step of retrieving and analyzing user session data for correlation with the data file upload operation, wherein the user session data may occur before, after, and/or concurrently with the data file upload operation.

20. The method of claim 19, wherein the user session data includes at least one of the group consisting of a screenshot from the user computer, a second user interface action, a user session log, and actions on the source file prior to the first user interface action.

21. The method of claim 20, further comprising the step of transmitting the user interface action and/or the user session data to an external server.
